(19) United States
(12) Patent Application Publication
(10) Pub. No.: US 2009/0034604 A1
(43) Pub. Date: Feb. 5, 2009

(54) METHOD AND SYSTEM FOR SUBDIVIDING A DIGITAL BROADCAST PROGRAM INTO DISTINCT IDENTIFIED SECTIONS FOR SELECTIVE DIGITAL VIDEO RECORDING AND ARCHIVING

(75) Inventors: Wayne M. Delia, Poughkeepsie, NY (US); Edward E. Kelley, Wappingers Falls, NY (US)

Correspondence Address: Cantor Colburn LLP - IBM Endicott, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/833,560

(22) Filed: Aug. 3, 2007

(51) Int. Cl. H04N 11/02

(52) U.S. Cl. 375/240.01; 375/E07.076

(57) ABSTRACT

A method for subdividing audio/video (A/V) content, includes: labeling a series of A/V content as individual sections; assembling the individual sections of the A/V content into a continuous series of segments; wherein a segment includes part or all of a section of A/V content; assigning sub-section identification to each segment of the continuous series of segments; wherein the sub-section identification is timestamp coordinated with the series of segments, and specifies a segment description, and timing control records for the A/V content within a segment; wherein the timing control records comprise start times and end times for each segment; and wherein the subdivision of the A/V content into identifiable sub-sections facilitates selective archiving, recording, and playback.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to digital audio/video recording, and more particularly to a method and system for subdividing a digital broadcast program into distinct identifiable sections for selective archiving and recording.

2. Description of the Related Art

Digital television (DTV) is a telecommunication system for broadcasting and receiving moving pictures and sound by means of a digital signal, in contrast to an analog signal used by analog (traditional) TV. DTV utilizes the digital modulation of analog signal data, which is digitally compressed prior to recording or broadcast. The digitally compressed signal requires decoding by a specially designed receiver within a television set, or a standard receiver with a set-top box, or a PC fitted with a television card. Digital television has several advantages over traditional analog TV, the most significant being that digital channels take up less bandwidth space. The reduced bandwidth of a digital broadcast signal enables digital broadcasters to provide more digital channels in the same space, provide High-Definition (HD) digital service, or provide other non-television services such as pay-multimedia services or interactive services. Digital television also permits special services such as multicasting (more than one program on the same channel), electronic program guides, and program identification.

The Federal Communications Commission (FCC), the branch of the United States (U.S.) government that regulates the television and radio broadcast industries, has mandated that all U.S. television broadcasts will be exclusively digital as of Feb. 17, 2009. Furthermore, as of Mar. 1, 2007, all new television sets that can receive signals over-the-air, including pocket-sized portable televisions, must include digital or HDTV tuners so they can receive digital broadcasts.

Currently, electronic program guides and program identification information encoded with digital broadcast data streams are limited to parameters relating to an entire program, or at best indicators for the overall program as well as commercial break identification. Presently, information available to the viewer of a digital broadcast includes the title of the program, event, or show, a viewing rating, and a brief synopsis of the broadcast. Current digital broadcast recording capabilities are limited to recording only the entire show, with no capability to record only user-defined sections of the broadcast.

### SUMMARY OF THE INVENTION

Embodiments of the present invention include a method, service, and system for subdividing audio/video (A/V) content, the method includes: labeling a series of A/V content as individual sections; assembling the individual sections of the A/V content into a continuous series of segments; wherein a segment includes part or all of a section of A/V content; assigning sub-section identification to each segment of the continuous series of segments; wherein the sub-section identification is timestamp coordinated with the series of segments, and specifies a segment description, and timing control records for the A/V content within a segment; wherein the timing control records comprise start times and end times for each segment; and wherein the subdivision of the A/V content into identifiable sub-sections facilitates selective archiving, recording, and playback.

A method for user control of (A/V) content, the service includes: utilizing a series of sub-section identifiers assigned to A/V content to selectively record or playback individual segments; wherein the sub-section identifiers are timestamp coordinated with the series of segments, and specify a segment description, and timing control records for the A/V content within a segment; wherein the timing control records comprise start times and end times for each segment; and wherein one or more devices are configured with decoders and application software to recognize the sub-section identifiers, and provide a graphical user interface to facilitate the selection of specific segments for selective recording or playback.

A system for selective recording and playback of audio/video (A/V) content, the system includes: one or more A/V editing devices; one or more recording and playback devices; wherein the one or more A/V editing devices label a series of A/V content as individual sections; wherein the one or more A/V editing devices assemble the individual sections of the A/V content into a continuous series of segments; wherein a segment includes part or all of a section of A/V content; wherein the one or more A/V editing devices assign sub-section identification to each segment of the continuous series of segments; wherein the sub-section identification is timestamp coordinated with the series of segments, and specifies a segment description, and timing control records for the A/V content within a segment; wherein the timing control records comprise start times and end times for each segment; and wherein the subdivision of the A/V content into identifiable sub-sections facilitates selective archiving, recording, and playback by the one or more recording and playback devices.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for subdividing a digital broadcast program into distinct identifiable sections for selective archiving and recording.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram of a manual method for assembling timing control records for audio/video content according to embodiments of the invention.

FIG. 2 is a flow diagram of an automatic method for calculating timing control records for audio/video content according to embodiments of the invention.

FIG. 3 illustrates a flow diagram of broadcast sub-section menu selection in a digital audio/video recording environment according to embodiments of the invention.

The detailed description explains the preferred embodiments of the invention, together with advantages and features, by way of example with reference to the drawings.

### DETAILED DESCRIPTION

Many entertainment programs and shows may be divided into segments or subsections based on topics of interest or storylines. For example, daytime dramas, commonly referred to as “soap opera” shows contain distinct subsections that can be delineated and grouped into logically related segments, such as separate story lines with featured characters. In addition, newsmagazine shows and entertainment shows typically have well defined formats with news segments, monologues, interviews, or musical and performance entertainment. However, there is lack of a corresponding method and system to include identification information for segments or subsections of a digital audio and video broadcast.

Embodiments of the invention provide a method and system for subdividing a digital broadcast program into distinct identifiable sections for selective archiving and recording. The sub-section identification information is incorporated in the data stream of a digital video broadcast or within a pre-recorded medium (i.e., digital video disc (DVD), compact disc (CD), magnetic storage, etc.). The sub-section identification is timestamp coordinated with the video and audio streams, and specifies a segment description, start time, end time for the content within the sub-section. Digital video recorders (DVR), and other types of recording devices that are equipped with decoders and application software, according to embodiments of the invention, utilize the sub-section identification information to enable the recording of an entire program, or to record one or more sub-sections of the program. Pre-recorded medium configured with sub-section identification allow for selective playback of content, and improved cataloguing for archiving information.

The synchronized data stream of sub-section identification information also enables the partial downloading of TV shows on pod casting services, improved selective video on demand, and partial downloading to mobile communication devices for a discount over the price of the entire program. The ability to select and record only the desired sub-sections of a program saves on the space required to store the program, enabling perhaps 20 minutes of audio and video of interest, where there might not be sufficient space to record and store an entire hour of the program. Video, even with compression, requires large amounts of device memory. Mobile communication devices, such as cellular phones, have the ability to download and record digital video content, however do to mobile communication devices small size they have limited recording storage capacity. Therefore, selective recording of video content on a mobile communications device allows users to download and store the portions of video content they want within the constraints of the device's memory. Embodiments of the invention may be offered as a pay-per-view or subscription service, including a possible variable price for broadcast television events in which a program is partially recorded.

The sub-section identification provided by embodiments of the invention, facilitate electronic program guides (EPG) and graphical user interfaces (GUI) to display the distinct sub-sections available in an upcoming digital television program broadcast to enable a viewer to select one or more of the available program sub-sections for digital video recording. A further feature of embodiments of the invention facilitates the user in bringing together the different sub-sections of various interlaced story lines into continuous story lines, by rearranging and presenting a partially-recorded digital television broadcast program sorted by distinct sub-section identifier keys and sub-section interval start time, so that all video segments associated with a particular sub-section identifier key can be viewed as a contiguous unit.

Table 1 illustrates an embodiment of the invention, where three distinct storylines or themes are found in a televised program that has been digitally encoded with sub-section identifiers. When a television program is edited for the final version, identifiers for each program segment are added to the digital data, which contains the program. Each identifier consists of a key value corresponding to a descriptive text field. For example in Table 1, subsection identifier “2325078” corresponds with sub-section description “Character “X” in storyline 1.” The data provided in Table 1 is made available to the on-screen program guide, offering the partial recording capability as a selectable option when the system owner requests a program to be recorded.

TABLE 1

| Sub-section identifier | |
|---|---|
| “XYZ” show | Sub-section Description |
| 2325078 | Character “X” in storyline 1 |
| 2325084 | Character “Y” in storyline 2 |
| 2325204 | Characters “X” and “Y” in storyline 3 |
| 2300000 | Opening credits |
| 1000000 | Commercial break |
| 2999999 | Closing credits |

Table 2. illustrates how the digital data stream relates the sub-section identifier keys to segments of the broadcast with an associated starting point in the mixed audio/video stream, and an associated end point. For example sub-section identifier 2300000 corresponds with the sub-section description for the opening credits. The opening credits run for the first thirty seconds of the program “XYZ”. The opening credits are followed by two minutes of commercials, indicated by sub-section identifier 1000000, with an interval start time of 00:00:30 and an interval end time of 00:02:30. Following the commercial break, the first storyline segment identified with sub-section identifier 2325078 that corresponds to sub-section description “Storyline 1” commences at interval start time 00:02:30 and runs until interval end time 00:05:15. At interval start time 00:05:15 Storyline 2 begins as indicated by sub-section identifier 2325084. In a similar fashion, additional segments are identified until the closing credits corresponding to sub-section identifier 2999999 at interval start time 00:59:00 is reached.

TABLE 2

| Sub-section | Interval Start Time | Interval end time | Sub-section |
|---|---|---|---|
| identifier | (Hrs, Mins, Secs) | (Hrs, Mins, Secs) | description |
| 2300000 | 00:00:00 | 00:00:30 | Opening |
| | | | credits |
| 1000000 | 00:00:30 | 00:02:30 | Commercial |
| | | | break |
| 2325078 | 00:02:30 | 00:05:15 | Storyline 1 |
| 2325084 | 00:05:15 | 00:07:30 | Storyline 2 |
| 1000000 | 00:07:30 | 00:09:30 | Commercial |
| | | | break |
| 2325204 | 00:09:30 | 00:12:00 | Storyline 3 |
| 2325078 | 00:12:00 | 0015:15 | Storyline 1 |
| 2325204 | 00:15:15 | 00:17:45 | Storyline 3 |
| 2325084 | 00:17:45 | 00:20:00 | Storyline 2 |
| 1000000 | 00:20:00 | 00:22:00 | Commercial |
| | | | break |
| 2325078 | 00:22:00 | 00:24:30 | Storyline 1 |
| — | — | — | — |
| — | — | — | — |
| 2999999 | 00:59:00 | 01:00:00 | Closing credits |

A DVR equipped with decoders and application software utilize the information from Tables 1 and Tables 2 that is encoded in the data stream of a digital broadcast to selectively record one or more sub-sections of the program according to the users inputs to the DVR GUI or on screen menu. For example if the user only wishes to record storyline 2, they would enter their selection into the DVR GUI or on screen menu. In a similar fashion, during the playback of pre-recorded audio and video encoded with the sub-section identifier information, a user can utilize the GUI of the playback device to select and arrange the portions of the presentation they wish to view and listen to.

The ability to pick from available designated sub-sections of a broadcast is an effective method of eliminating commercials from the recording. However, commercial elimination may not be desirable in the business model of the digital service provider or broadcast network. This may be overcome by requiring a certain percentage (or all) of the commercials to be recorded along with the requested sub-sections. Alternatively, the selective segment recording and viewing service may be offered for a slight additional premium charge applied to the viewer's monthly bill.

The creation and synchronization of sub-section identification information to the digital audio and video content can be done manually during the programs creation, or can be created automatically by calculating the start time and end time based on the size of the digital video or audio file.

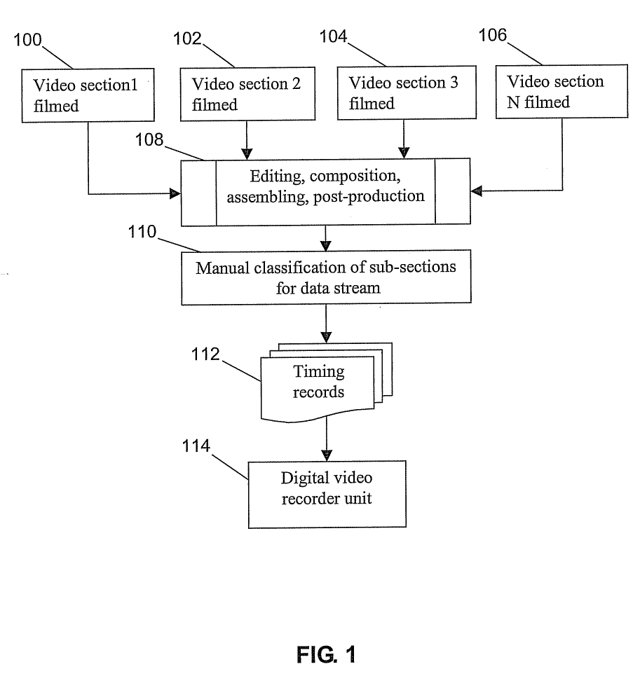

FIG. 1 is a flow diagram of an exemplary manual method for assembling timing control records for audio/video (A/V) content according to embodiments of the invention. Various scenes are filmed and labeled as video sections 1 through N (blocks 100, 102, 104, 106). The raw video sections are then edited, composed, and assembled in a post-production studio (block 108). A reviewer manually categorizes and classifies the post-production video into segments (block 110) with sub-section identifiers, subsection descriptions, and timing records (interval start and end times) (block 112). The sub-section identification information is synchronized and added to each segment and the overall data stream with a digital video recorder unit (block 114).

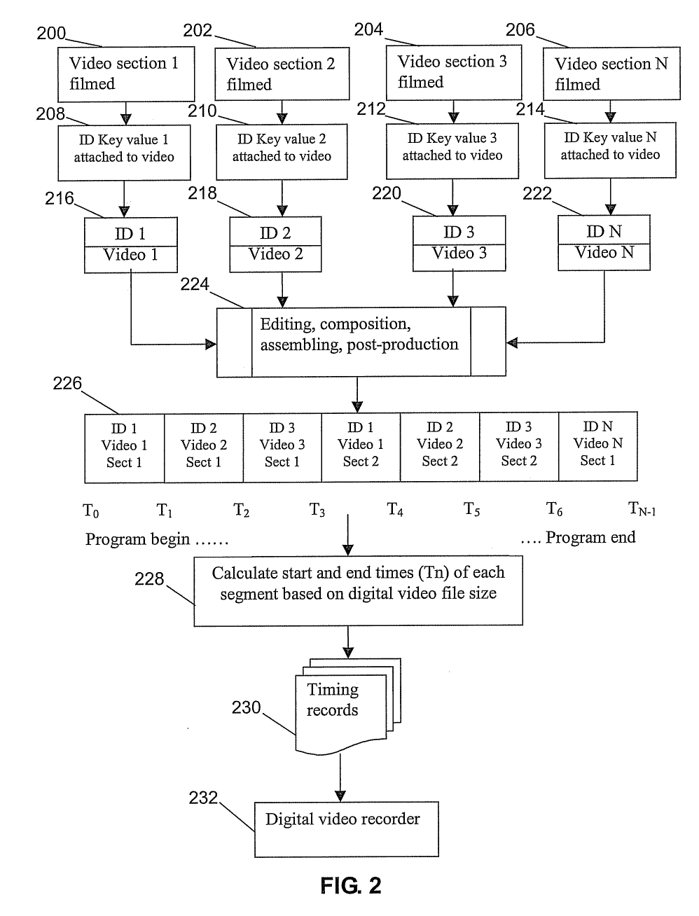

FIG. 2 is a flow diagram of an exemplary automatic method for calculating timing control records for audio/video content according to embodiments of the invention. Various scenes are filmed and labeled as video sections 1 through N (blocks 200, 202, 204, 206), and a series of identification (ID) key values (blocks 208, 210, 212, 214) are automatically attached to the filmed video sections 1 through N (blocks 200, 202, 204, 206), respectively. The identified video sections (blocks 216, 218, 220, 222) are then edited, composed, and assembled in a post-production studio (block 224), with ID key values and section numbers remaining integral with their original filmed video section footage (block 226), even after filmed video section footage (blocks 200, 202, 204, 206) is broken up and rearranged into composed video content. The start and end times are calculated automatically (block 228), and the values are assigned to the time tags T₀ through Tₙ₋₁ as timing records (block 230) of the composed video content (block 226), based on the size of the digital video section file and the compression technique used. For example, if the video file is recorded at 20 KB/s (kilobits per second), and the file size is 10 MB (mega bits) from T0 to T1, the length of the segment is 500 seconds or equivalently expressed as 8 minutes and 20 seconds. A digital video recording device (block 232) merges and synchronizes the timing records with the assembled sub-section video segments.

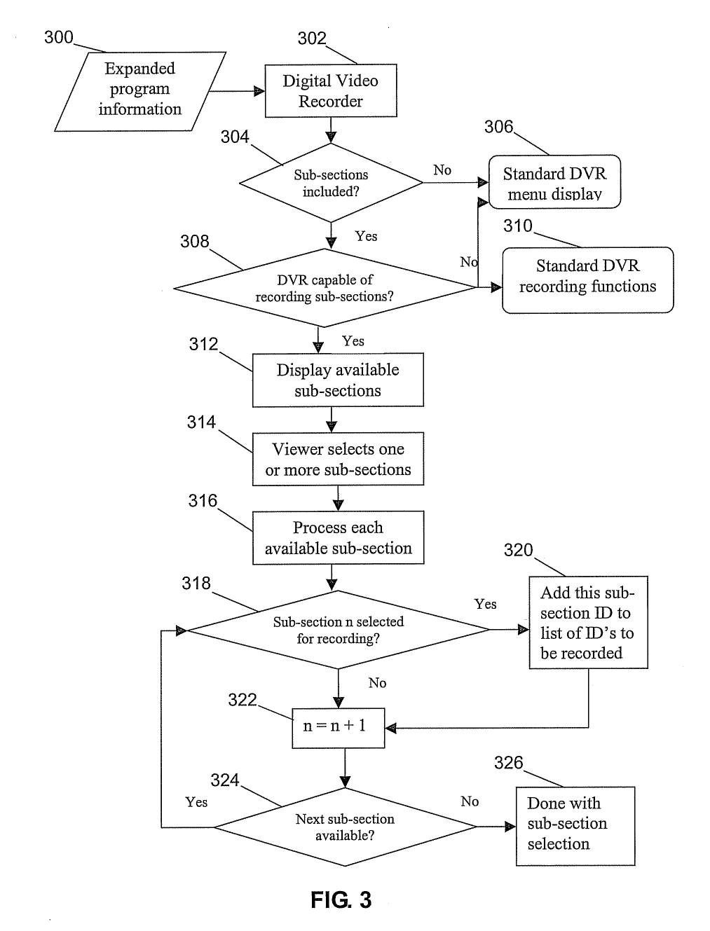

FIG. 3 illustrates a flow diagram of broadcast subsection menu selection in a digital video recording environment according to embodiments of the invention. An expanded program information data stream (block 300) is downloaded into a DVR (block 302) from at least one of the following: over the air reception, cable, satellite, Internet, or other known means for transmitting programming information for EPGs. If sub-section information is not included in the data stream (decision block 304 is No), a standard DVR GUI menu is displayed (block 306). If the sub-section information is included in the data stream (decision block 304 is Yes), but the receiving DVR (block 302) is not capable of recording sub-sections (decision block 308 is No), a standard DVR GUI menu is displayed (block 306), and standard DVR recording functions (block 310) are carried out. Standard recording functions only allow for the recording of the whole program, or for user defined time intervals. However, if the sub-section information is included in the data stream (decision block 304 is Yes), and the receiving DVR (block 302) is capable of recording sub-sections (decision block 308 is Yes), the EPG or GUI menu of the DVR (block 302) displays the available sub-sections (block 312). The viewer may then select one or more of the sub-sections (block 314), which are then processed (block 316). The DVR (block 302) determines which sub-sections were selected for recording (decision block 318). If a subsection has been selected for recording (decision block 318 is Yes), the selected sub-sections ID is added to a list of subsection ID to be recorded (block 320). The DVR (block 302) incrementally (block 322) reviews each of the sub-sections (blocks 324, 318) to determine if the sub-section's ID should be added to the record list (block 320). The DVR continues to review the sub-sections until there are no more available (decision block 324 is No), and completes the sub-section review selection (block 326).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for subdividing audio/video (A/V) content, the method comprising:
labeling a series of A/V content as individual sections;
assembling the individual sections of the A/V content into a continuous series of segments;
wherein a segment includes part or all of a section of A/V content;
assigning sub-section identification to each segment of the continuous series of segments;
wherein the sub-section identification is timestamp coordinated with the series of segments, and specifies a segment description, and timing control records for the A/V content within a segment;
wherein the timing control records comprise start times and end times for each segment; and
wherein the subdivision of the A/V content into identifiable sub-sections facilitates selective archiving, recording, and playback.

2. The method of claim 1, wherein the sub-section identification information is incorporated in the data stream of an A/V broadcast.

3. The method of claim 1, wherein the sub-section identification information is incorporated in the data stream of an A/V broadcast; and
wherein one or more recording devices utilize the sub-section identification information to enable the selective recording of one or more sub-sections.

4. The method of claim 3, wherein the one or more recording devices are configured with decoders and application software to recognize the sub-section identification information, and provide a graphical user interface to facilitate the selection of specific sub-sections for selective recording or archiving.

5. The method of claim 3, wherein a variable fee is charged based on the number sub-sections selected for recording.

6. The method of claim 3, wherein the sub-sections are recorded in a user defined order.

7. The method of claim 1, wherein the sub-section identification information is incorporated in the data stream of a pre-recorded medium.

8. The method of claim 1, wherein the sub-section identification information is incorporated in the data stream of a pre-recorded medium; and
wherein one or more devices utilize the sub-section identification information to enable the selective playback of one or more sub-sections.

9. The method of claim 8, wherein the one or more devices are configured with decoders and application software to recognize the sub-section identification information, and provide a graphical user interface to facilitate the selection of specific sub-sections for selective playback.

10. The method of claim 8, wherein a variable fee can be charged based on the number sub-sections selected for playback.

11. The method of claim 1, wherein all segments associated with a particular sub-section identifier can be viewed as a contiguous unit.

12. The method of claim 1, wherein the sub-section identification information is synchronized and added to each segment with a digital video recorder unit.

13. The method of claim 1, wherein the timing control records are automatically calculated based on the size of the segment and the compression rate.

14. A method for user control of audio/video (A/V) content, the method comprising:
utilizing a series of sub-section identifiers assigned to A/V content to selectively record or playback individual segments;
wherein the sub-section identifiers are timestamp coordinated with the series of segments, and specify a segment description, and timing control records for the A/V content within a segment;
wherein the timing control records comprise start times and end times for each segment; and
wherein one or more devices are configured with decoders and application software to recognize the sub-section identifiers, and provide a graphical user interface to facilitate the selection of specific segments for selective recording or playback.

15. The method of claim 14, wherein the sub-section identifiers are incorporated in the data stream of an A/V broadcast.

16. The method of claim 14, wherein a variable fee is charged based on the number segments selected for recording or playback.

17. The method of claim 14, wherein the segments are recorded or played back in a user defined order.

18. The method of claim 14, wherein all segments associated with a particular sub-section identifier can be viewed as a contiguous unit.

19. A system for selective recording and playback of audio/video (A/V) content, the system comprising:
one or more A/V editing devices;
one or more recording and playback devices;
wherein the one or more A/V editing devices label a series of A/V content as individual sections;
wherein the one or more A/V editing devices assemble the individual sections of the A/V content into a continuous series of segments;
wherein a segment includes part or all of a section of A/V content;
wherein the one or more A/V editing devices assign sub-section identification to each segment of the continuous series of segments;
wherein the sub-section identification is timestamp coordinated with the series of segments, and specifies a segment description, and timing control records for the A/V content within a segment;
wherein the timing control records comprise start times and end times for each segment; and
wherein the subdivision of the A/V content into identifiable sub-sections facilitates selective archiving, recording, and playback by the one or more recording and playback devices.

20. The system of claim 19, wherein the one or more recording and playback devices are configured with decoders and application software to recognize the sub-section identification information, and provide a graphical user interface to facilitate the selection of specific sub-sections for selective recording, archiving, and playback.
